(19) United States
(12) Patent Application Publication
(10) Pub. No.: US 2017/0055649 A1
(43) Pub. Date: Mar. 2, 2017

(54) SUPPORT FOR ILLUMINATION DEVICE ATTACHABLE TO A SUN-SHADE

(71) Applicant: Leslie GEERAERTS, Farnborough Kent (GB)

(72) Inventor: Leslie GEERAERTS, Farnborough Kent (GB)

(21) Appl. No.: 15/304,324

(22) PCT Filed: Mar. 31, 2015
(86) PCT No.: PCT/GB2015/050983

§ 371 Date: Oct. 14, 2016

(30) Foreign Application Priority Data
Apr. 1, 2014 (GB) 1405853.1

(51) Int. Cl. A45B 3/02; F21V 21/08; F21V 33/00; A45B 23/00

(52) U.S. Cl. CPC A45B 3/02; A45B 23/00; F21V 21/0832; F21V 33/006; F21V 35/00

(57) ABSTRACT

The present invention relates to illumination, in particular to illumination for garden parasols and similar products, such as canopies. In particular, we describe a device for illuminating a parasol comprising a bracket having an upper mounting element for attachment to an upper portion of a parasol; a lower mounting element for attachment to a lower portion of a pole of the parasol; and a support for supporting an illumination product in a spaced relationship from the pole.

The present invention relates to illumination, in particular to illumination for garden parasols and similar products, such as canopies.

Garden parasols and canopies are well known. Parasols are typically supported by a heavy base, they may be free standing or held by an aperture in a garden table.

Various means of providing illumination to the parasol have been proposed, including battery-operated lights attachable to the pole of the parasol. Many people have wound battery or mains-powered fairy lights (also known as, inter alia, Christmas lights or twinkle lights) around the pole and stretcher components of the parasol. The present invention seeks to provide a means to allow the mounting of a candle or candle holder to the parasol.

Accordingly, in its broadest sense, the present invention provides a parasol illumination device or support comprising a bracket having an upper mounting element for attachment to an upper portion of a parasol; a lower mounting element for attachment to a lower portion of a pole of the parasol; and an illumination support for supporting an illumination product in a spaced relationship from the pole.

In one embodiment, the upper mounting element comprises a hook. Preferably, the hook is adapted to engage at least one stretcher of the parasol or the runner of the parasol. Alternatively, the hook is adapted to be mountable to the top notch of the parasol.

Suitably, the lower mounting element includes a tie.

Alternatively or additionally, the lower mounting element comprises a mount adapted to engage the pole of the parasol. Suitably, the mount is in the form of a saddle or cup.

In one embodiment, the support is in the form of a hook to which an illumination product may be hung. In an alternative embodiment, the support is in the form of a plate upon which a candle or other illumination device is mountable or a lantern, basket, cage or cup into which a candle or other illumination device can be placed. The cup may have open or closed walls.

Preferably, the support and upper mounting element are held in a spaced relationship by an upper brace element.

Preferably, the support and lower mounting element are held in a spaced relationship by a lower brace element.

Suitably, the upper and lower brace elements define a generally triangular geometry with the pole of the parasol.

The above and other aspects of the present invention will now be described in further detail, by way of example only, with reference to the accompanying drawings, in which:

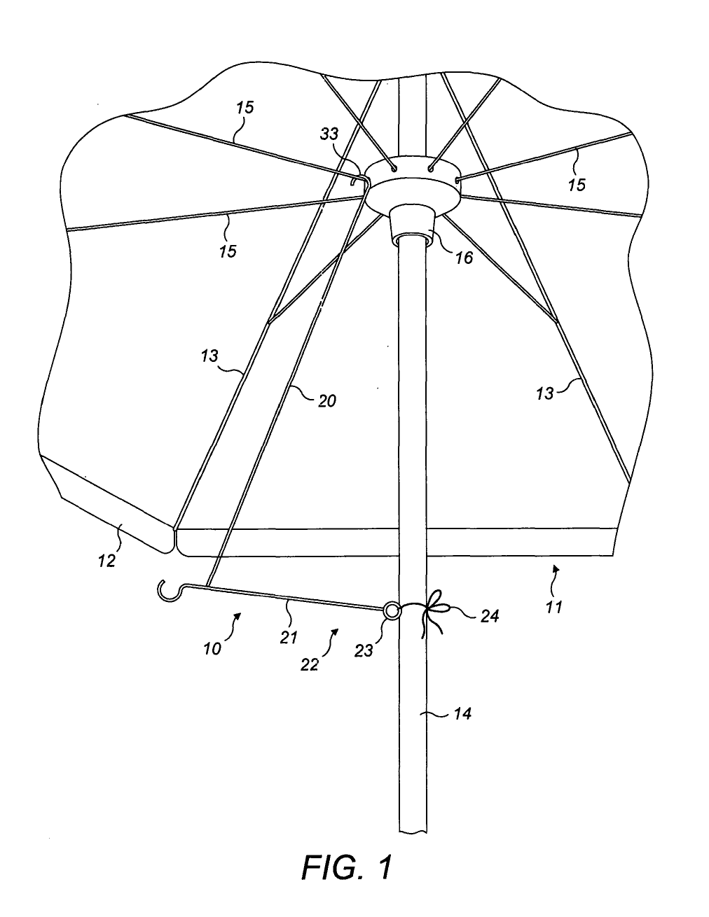

FIG. 1 is a schematic perspective part view of a parasol including a first embodiment of a parasol illumination device or support in accordance with the present invention; and

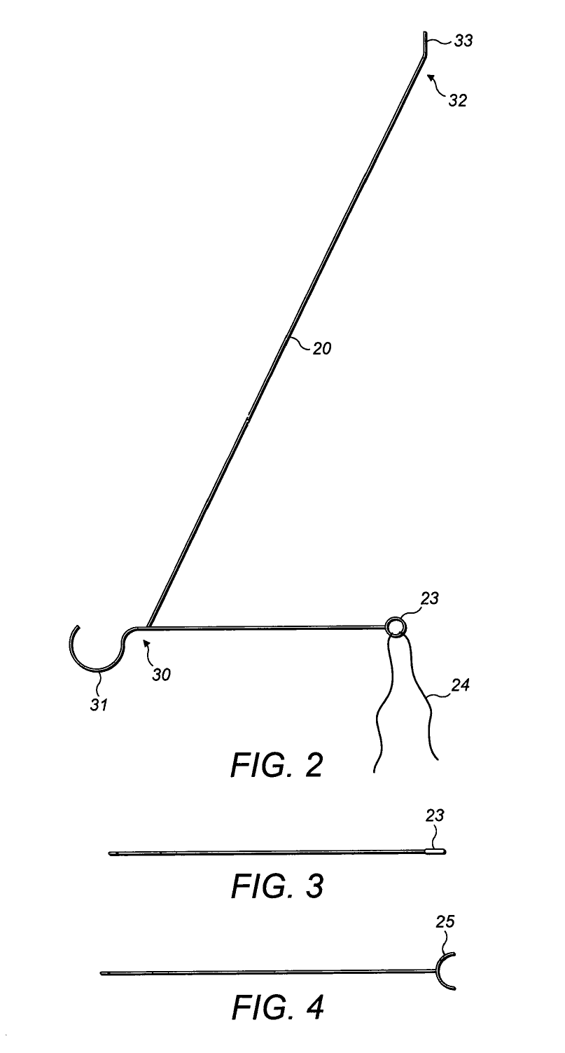

FIG. 2 is a side view of the parasol illumination device of FIG. 1;

FIG. 3 is a plan view of the parasol illumination device of FIG. 1;

FIG. 4 is a plan view of a second embodiment of a parasol illumination device in accordance with the present invention;

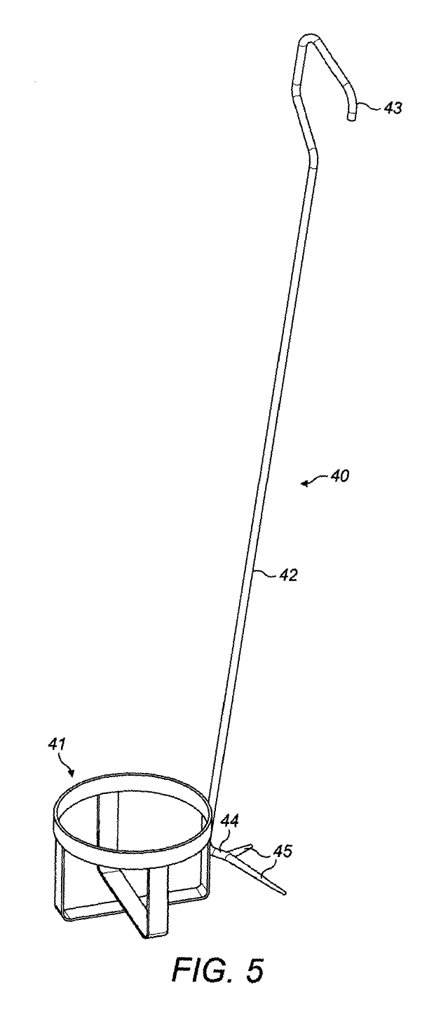

FIG. 5 is a perspective view of a further embodiment of a parasol illumination device in accordance with the present invention; and

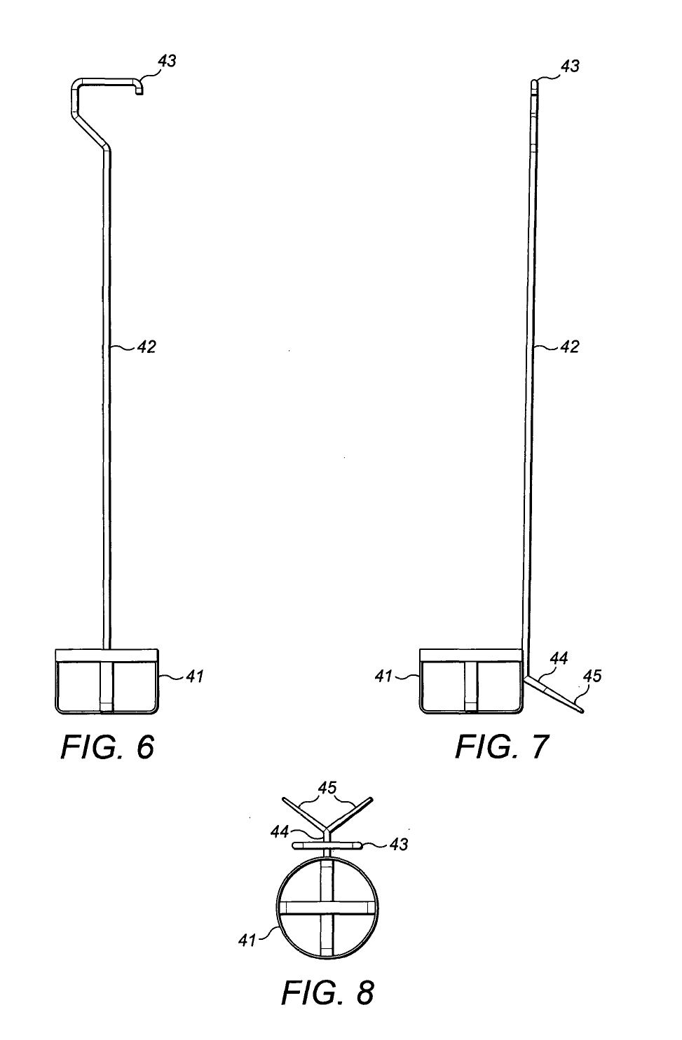

FIGS. 6 to 8 are front, side and plan views respectively of the embodiment of FIG. 5.

FIG. 1 shows an embodiment of a parasol illumination device 10 in accordance with the present invention mounted to a parasol 11. The parasol is of conventional construction, having a canopy 12 supported by ribs 13 carried at their upper ends (not shown) on a central pole 14. Ribs 13 are tied through stretchers 15, typically metal or wooden, to a runner 16 carried by pole 14. The parasol is movable between a collapsed configuration and a deployed configuration by a longitudinal movement of runner 16 up pole 14.

Parasol illumination device 10 comprises upper and lower elongate brace elements 20, 21. Lower brace element 21 extends, in use, generally outwardly from pole 14 of the parasol and has a proximal end 22 provided with attachment means for attachment to the pole and a distal end 30 which joins with upper brace element 20. In the embodiment shown in FIGS. 1 to 3, the attachment means comprises a ring 23 to which a tie 24 is mounted. Tie 24 is used to secure lower brace element 21 to the pole.

In the modification shown in plan view in FIG. 4, the attachment means comprises an elongate saddle 25. Saddle 25 provides a more secure engagement with the cylindrical geometry of the pole. Preferably, a tie is also included in this embodiment.

A distal end 30 of lower brace element 21 is formed a support 31 for an illumination product. In the embodiment shown, support 31 is in the form of a hook from which a illumination product having a hanging component can be hung, for example, a lantern or a candle of the type moulded within a glass container having a carrying handle or an oil burner. In alternative embodiments (not shown), support 31 is in the form of a plate upon which the illumination product can be placed. For candles, preferably, the plate includes a central spike to allow securing of the candle to the support.

Upper brace element 20 has a proximal end 32 forming an upper end and including an upper mounting element for attachment to a suitable upper part of the parasol. In the embodiment shown, upper mounting element is in the form of a hook 33, attachable to a stretcher of the parasol. The hook 33 may be adapted to be attachable to just one stretcher or may be enlarged to attach over two adjacent stretchers. In alternative embodiments, two hooks are provided to hook over three adjacent stretchers or over two non-adjacent stretchers.

In alternative embodiments (not shown), upper mounting element may be couplable to the runner 16, the upper notch of the parasol or to the pole itself. Distal end 33 of upper brace element 20 is coupled to lower brace element 21 in the region of the distal end 30 thereof, such that the parasol illumination device defines, along with pole 14, a generally triangular geometry.

The parasol illumination device may be made of any suitable material, such as wrought iron, cast metal (such as iron, steel or aluminium) or injection-moulded plastics materials. Alternatively, the device may be formed of wirework, formed to a suitable shape. The device may further include additional features, such as additional ornamentation in the space between the bracing elements 20, 21. The device may further include additional supports to provide support for more than one illuminating product.

FIGS. 5 to 8 show a further embodiment of the device of the present invention. The parasol illumination device includes a support 41 for an illumination product (not shown). Support 41 is in the form of a basket or open-sided cup. An upper brace element in the form of a bar 42 couples support 41 to a hook 43 for attachment to a stretcher of a parasol. A lower brace element 44 terminating in a pair of fingers 45 forming a saddle acts to space the illumination support 41 from the central pole of a parasol.

It will be apparent from the description that, although described with respect to a parasol, the device of the present invention is equally suitable for attachment to similar apparatus, such as other forms of sun shade or canopy having suitable upper and lower mounting positions, such as gazebos, especially of the collapsible or self-erecting type or, indeed, to a hook mounted to a vertical surface such as a wall. It will be appreciated that hook 33 is fittable over the corner framework of the apparatus with tie 24 attachable to a vertical leg.

1. An illumination device for a parasol having a pole comprising a bracket having an upper mounting element for attachment to an upper portion of a parasol; a lower mounting element for attachment to a lower portion of the pole of the parasol; and a support for supporting an illumination product in a spaced relationship from the pole.

2. A device as claimed in claim 1 wherein the upper mounting element is adapted to engage a stretcher of the parasol or the runner of the parasol or is adapted to be mountable to the top notch of the parasol.

3. A device as claimed in claim 1 wherein the upper mounting element comprises a hook.

4. A device as claimed in claim 1 wherein the lower mounting element comprises a tie.

5. A device as claimed in claim 1 wherein the lower mounting element comprises a mount adapted to engage the pole of the parasol.

6. A device as claimed in claim 5 wherein the mount is in the form of a saddle or cup.

7. A device as claimed in claim 1 wherein the support is in the form of a hook, a basket, a cage, a lantern or a plate.

8. A device as claimed in claim 1 wherein the support and upper mounting element are held in a spaced relationship by an upper brace element.

9. A device as claimed in claim 1 wherein the support and lower mounting element are held in a spaced relationship by a lower brace element.

10. A device as claimed in claim 1 wherein the upper and lower brace elements define, in use, a generally triangular geometry with the pole of the parasol.

11. A device as claimed in claim 2 wherein the upper mounting element comprises a hook.

12. A device as claimed in claim 2 wherein the lower mounting element comprises a tie.

13. A device as claimed in claim 3 wherein the lower mounting element comprises a tie.

14. A device as claimed in claim 2 wherein the lower mounting element comprises a mount adapted to engage the pole of the parasol.

15. A device as claimed in claim 3 wherein the lower mounting element comprises a mount adapted to engage the pole of the parasol.

16. A device as claimed in claim 4 wherein the lower mounting element comprises a mount adapted to engage the pole of the parasol.

17. A device as claimed in claim 2 wherein the support is in the form of a hook, a basket, a cage, a lantern or a plate.

18. A device as claimed in claim 3 wherein the support is in the form of a hook, a basket, a cage, a lantern or a plate.

19. A device as claimed in claim 4 wherein the support is in the form of a hook, a basket, a cage, a lantern or a plate.

20. A device as claimed in claim 5 wherein the support is in the form of a hook, a basket, a cage, a lantern or a plate.
